(19) United States
(12) Patent Application Publication
(10) Pub. No.: US 2008/0191935 A1
(43) Pub. Date: Aug. 14, 2008

(54) Method, Computer Program Product and Apparatus for Selecting a Satellite Navigation System Module

(75) Inventor: Travis Tidwell, Tulsa, OK (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Navico Inc.

(21) Appl. No.: 11/674,823

(22) Filed: Feb. 14, 2007

(51) Int. Cl. G01S 5/14

(52) U.S. Cl. 342/357.02; 342/357.06

(57) ABSTRACT

An apparatus for selecting a satellite navigation system module includes a communication interface element and a selecting element. The communication interface element is configured to receive a first positioning message from a first satellite navigation system module, and to receive a second positioning message from a second satellite navigation system module. The selecting element is configured to compare a descriptive characteristic of the first and second positioning messages, and to select the positioning message having a preferred descriptive characteristic.

### FIELD OF THE INVENTION

Embodiments of the present invention generally relate to satellite navigation system utilization and, more particularly, relate to selecting a satellite navigation system module within a network of satellite navigation system modules.

### BACKGROUND OF THE INVENTION

The global positioning system, which is usually referred to as GPS, is a well known satellite navigation system. GPS enables very accurate location determination or position fixing by utilizing measurements of precise timing signals broadcast from a constellation of more than two dozen GPS satellites in orbit around the earth. Location can be determined, for example, in terms of longitude, latitude, and altitude regardless of time, weather and location. Accordingly, GPS has become a vital tool for not only navigation in the air, on land and at sea, but also for map-making and land surveying.

Another known satellite navigation system, the International Global Navigation Satellite System (GNSS) Service or IGS, has incorporated NAVSTAR satellites of the United States and GLONASS satellites from Russia along with additional satellite constellations to provide a very robust navigation capability. Essentially IGS provides increased precision in location determination and enables the utilization of enhancements in the capabilities of satellite navigation system devices. Accordingly, it should be understood that, as used herein, the term satellite navigation system is meant to encompass any of a number of different systems including, for example, GPS, IGS, GNSS, NAVSTAR, GLONASS, etc.

More particularly with respect to GPS, given its clear utility, GPS receivers or modules capable of receiving GPS satellite broadcasts for location determination are in high demand for the provision of increased levels of service within numerous industries. Additionally, given the continuing reduction in the size and cost of highly capable electronic devices, GPS modules are becoming more commonly encountered and used by consumers. For example, the telecommunications industry has placed GPS modules in mobile terminals such as cellular phones for the provision of location-based services, the automotive industry has placed GPS modules in automobiles for the provision of guidance services, and the maritime industry has placed GPS modules on ships for the provision of services related to safe navigation.

Despite the increased frequency with which GPS modules are encountered in the daily life of consumers, GPS modules are not without limitations. For example, GPS modules may be damaged or destroyed in accidents or with improper maintenance or use. Additionally, the accuracy of a GPS module may depend upon the GPS satellites with which the GPS module is capable of communicating. Moreover, noisy environments or weak signals may contribute to a low signal-to-noise ratio (SNR) for a received signal, which may degrade the utility of the received signal. In order to provide increased safety, security or convenience, certain consumers and manufacturers have elected to employ multiple GPS modules to introduce redundancy. Accordingly, if one GPS module suffers degradation, another GPS module may be placed online to compensate.

Unfortunately, even given a system with redundant GPS modules, the full capabilities of the redundancy may not be utilized since there is currently no mechanism for automatically selecting a particular one of the GPS modules based on accuracy metrics. Accordingly, it may be desirable to develop a system capable of addressing this current deficiency.

### BRIEF SUMMARY OF THE INVENTION

Accordingly, in order to provide a mechanism by which to utilize the capabilities of redundant systems, a method, computer program product and apparatus are provided for selecting a satellite navigation system (e.g., GPS, IGS, GNSS, NAVSTAR, GLONASS, etc.) module. Embodiments of the present invention employ a selection unit that may be in communication with a plurality of satellite navigation system modules via a network for selecting a module that, in terms of an accuracy metric or other criteria, may provide an output of a more accurate location fix or other information.

In one exemplary embodiment, a method is provided for selecting a satellite navigation system module. The method includes receiving a first positioning message from a first satellite navigation system module, receiving a second positioning message from a second satellite navigation system module, comparing a descriptive characteristic of the first and second positioning messages, and selecting the positioning message having a preferred descriptive characteristic based on the comparison.

In another exemplary embodiment, a computer program product is provided for selecting a satellite navigation system module. The computer program product includes at least one computer-readable storage medium having computer-readable program code portions stored therein. The computer-readable program code includes multiple executable portions. The first executable portion is for receiving a first positioning message from a first satellite navigation system module. The second executable portion is for receiving a positioning message from a second satellite navigation system module. The third executable portion is for comparing a descriptive characteristic of the first and second positioning messages. And the fourth executable portion is for selecting the positioning message having a preferred descriptive characteristic based on the comparison.

In yet another exemplary embodiment, an apparatus is provided for selecting a satellite navigation system module selection. The apparatus includes a communication interface element and a selecting element. The communication interface element is configured to receive a first positioning message from a first satellite navigation system module, and to receive a second positioning message from a second satellite navigation system module. The selecting element is configured to compare a descriptive characteristic of the first and second positioning messages, and to select the positioning message having a preferred descriptive characteristic based on the comparison.

Embodiments of the invention provide an ability to determine that a particular satellite navigation system module such as a GPS module should replace another satellite navigation system module as a lead module in order to ensure that the lead module provides the most accurate location fix relative to the other satellite navigation system modules within a given tolerance. As a result, system capabilities may be enhanced without repeated user intervention.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a basic block diagram illustrating a system for automatically selecting a GPS module according to an exemplary embodiment of the present invention;

FIG. 2 is a basic block diagram illustrating an example of operation of the system for automatically selecting a GPS module selection according to an exemplary embodiment of the present invention;

FIG. 3 is a basic block diagram of a head unit according to an exemplary embodiment of the present invention; and

FIG. 4 is a flowchart according to an exemplary method of automatically selecting a GPS module according to one embodiment of the present invention.

### DETAILED DESCRIPTION OF THE INVENTION

Embodiments of the present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like reference numerals refer to like elements throughout. Additionally, although embodiments of the present invention will be described below in terms of GPS, any of a number of other satellite navigation systems could be used in conjunction with embodiments of the present invention including, for example, IGS, GNSS, NAVSTAR, GLONASS, etc. Thus, GPS is merely used for purposes of example and not of limitation.

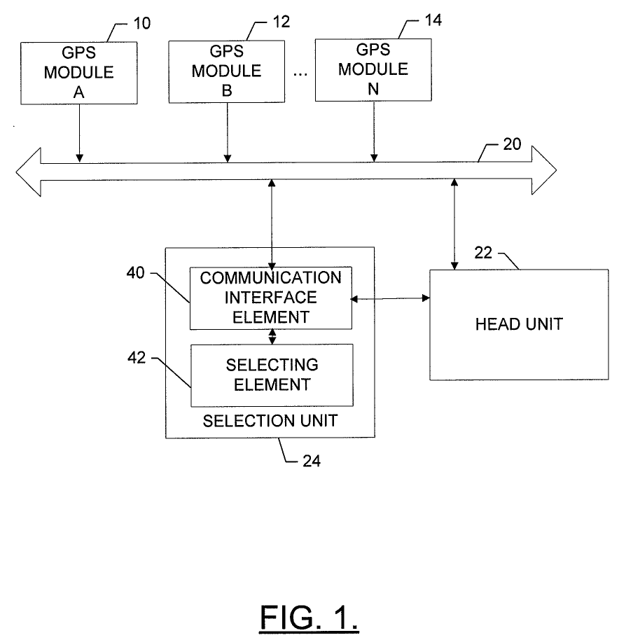

FIG. 1 is a basic block diagram illustrating a system for automatically selecting a GPS module, such as automatically selecting a GPS module, according to an exemplary embodiment of the present invention. The system includes N GPS modules, three being shown as a first GPS module 10 (GPS A), a second GPS module 12 (GPS B) and an Nth GPS module 14 (GPS N). Although FIG. 1 shows three GPS modules, the system may include any number of GPS modules including, for example, two GPS modules (i.e., N=2) or even many more GPS modules (i.e., N>2). The GPS modules may be GPS receivers configured to receive GPS satellite signals and thereafter transmit location fix information based on the GPS satellite signals, such as in the form of a GPS positioning message. This may be accomplished according to techniques and using equipment and software programs that are well known in the art, such as equipment compatible with conventional GNSS positioning messages.

The GPS positioning messages may be any messages capable of carrying at least location information and an associated descriptive characteristic. In this regard, the GPS positioning messages may be, for example, GNSS messages or any other type of suitable positioning message. The descriptive characteristic may include a quality metric or measure indicative of the quality of the location fix of the respective location information. It should be understood that the quality measure of the location fix could be expressed in any of a number of different manners including, for example, in terms of an accuracy measure or an error measure. In an exemplary embodiment, the quality measure may include a PDOP (position dilution of precision) value, which is known in the art to provide a parameter for measurement of position error. In this regard, a lower PDOP is generally indicative of greater precision or higher position accuracy. For example, a location fix with a PDOP of two generally indicates a higher degree of accuracy than a location fix with a PDOP of five. The descriptive characteristic could also be SNR, which is generally a factor used in PDOP calculation. In other exemplary embodiments, the descriptive characteristic could be an HDOP (horizontal dilution of precision) or a VDOP (vertical dilution of precision) value, both of which may be included, among other data, in the PDOP value. In yet another exemplary embodiment, the descriptive characteristic could be a TDOP (time dilution of precision) value. Further, for example, the descriptive characteristic could include information regarding the type of fix such as, for example, information regarding the GNSS method, or whether the fix is a two-dimensional (2D) or three-dimensional (3D) fix.

Each of the first, second and Nth GPS modules 10, 12 and 14 may be in communication with a network 20. The network 20 may be any communication backbone or framework that is known in the art. The network 20 may communicate with the first, second and Nth GPS modules 10, 12 and 14 in accordance with any of a number of suitable communication protocols including, for example, the NMEA 2000 protocol.

The system may also include a head unit 22 and a selection unit 24 that are also in communication with the network 20. In an exemplary embodiment, multiple head units (e.g., repeater units) may be in communication with the network 20. Among other things, the head unit 22 may be configured for receiving GPS positioning messages from any of the first, second and Nth GPS modules 10, 12 and 14 and displaying a location based on one or more of the received GPS positioning messages. As an alternative embodiment, the network 20 could be omitted from the system and each of the first, second and Nth GPS modules 10, 12 and 14 may be in communication directly with the selection unit 24. Such an alternative embodiment may be employed, for example, by utilizing a plurality of discrete inputs into which each of the first, second and Nth GPS modules 10, 12 and 14 may be plugged to create a plurality of one-to-one connections (e.g., as provided by NMEA 0183). As such, it should be appreciated that the embodiment of FIG. 1 is merely exemplary.

In an exemplary embodiment, the selection unit 24 may operate as a gateway through which GPS positioning messages are communicated between GPS modules 10, 12, 14 and the head unit 22. The selection unit 24 may be configured to receive GPS positioning messages provided from any of the GPS modules 10, 12, 14, but may only communicate selected GPS positioning messages to the head unit 22 for output, for example, via a display (display 27, described below). Alternatively, each GPS positioning message may be communicated to the head unit 22, with selected GPS positioning messages being indicated as “active” messages and the remaining messages being considered as “inactive” or backup messages. In either situation, the head unit 22 may utilize information pursuant to the control of the selection unit 24. In other words, the selection unit 24 may select which of the incoming GPS positioning messages meet respective criteria for use by the head unit 22.

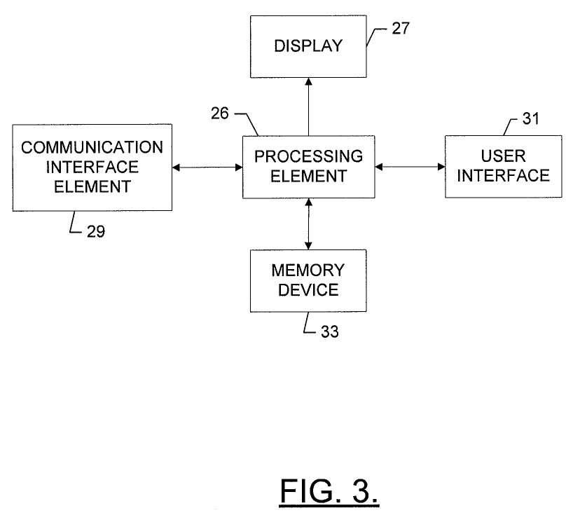

More particularly, as shown in FIG. 3, the head unit 22 may include a processing element 26, a display 27, a communication interface element 29, and a user interface 31. The head unit 22 may also include a memory device 33 having, for example, volatile and/or non-volatile memory. The memory device 33 could be, for example, a flash memory. The memory device could be configured to store information, data, applications, instructions or the like for enabling the head unit to carry out various functions in accordance with exemplary embodiments of the present invention. For example, the memory could be configured to buffer input data for processing by the processing element 26, and/or to store historical information. In an exemplary embodiment, the memory device 33 may be a circular buffer that automatically deletes information having a specified age. In such a situation, average and/or probability values may be calculated over a specified period of time such as the period of time covered by the circular buffer, or a specified portion of the period of time covered by the circular buffer based on the historical information.

The processing element 26 may be embodied in many ways. For example, the processing element 26 may be embodied as a processor, a coprocessor, a controller or various other processing means or devices including integrated circuits such as, for example, an ASIC (application specific integrated circuit). In an exemplary embodiment, the processing element 26 may be configured to execute instructions stored in the memory device 33 or otherwise accessible to the processing element 26. Meanwhile, the display 27 may be, for example, a conventional LCD (liquid crystal display) or any other suitable display known in the art upon which images may be rendered.

The communication interface element 29 may be embodied as any device or means embodied in either hardware, software, or a combination of hardware and software that is capable of receiving and/or transmitting data from/to the network 20. The user interface 31 may include, for example, a keyboard, keypad, function keys, mouse, scrolling device, touch screen, or any other mechanism by which a user may interface with the head unit 22.

Returning to FIG. 1, the selection unit 24 may be embodied as any device or means embodied in either hardware, software, or a combination of hardware and software that is capable of receiving GPS positioning messages from multiple GPS modules 10, 12, 14 and selecting one of the GPS modules based on a comparison of the descriptive characteristics (or some other criteria) in at least some, if not all, of the GPS positioning messages. The selection unit 24 may include a communication interface element 40 and a selecting element 42 that may enable the selection unit 24 to select certain ones of the received GPS positioning messages for processing to provide a location fix to the head unit 22. In this regard, the communication interface element 40 may be configured for communicating with the GPS modules 10, 12, 14 and the head unit 22, for example, via the network. The communication interface element 40 may be configured to receive incoming GPS positioning messages from each of the GPS modules. The selecting element 42 may be in communication with the communication interface element 40 to receive at least the descriptive characteristic of each corresponding incoming GPS positioning message. The selecting element 42 may be configured to perform comparisons of corresponding descriptive characteristics as described above and subsequently select one of a plurality of GPS modules as a lead module, while others are designated as spare modules. In this regard, the lead module may comprise the module from which selected GPS positioning messages (active messages) are received, while the spare modules may comprise the modules from which the remaining, unselected GPS positioning messages (inactive or backup messages) are received.

It should be noted that although FIG. 1 illustrates the selection unit 24 as being separate from the head unit 22, the selection unit 24 may alternatively be integrated within the head unit 22. Thus, for example, the processing element 26 of the head unit 22, may also control operation of the selection unit 24. Alternatively, the selection unit 24 may be controlled by a coprocessor or other such processing element locally disposed at the selection unit 24 or in another location. In this regard, the selection unit 24, including the communication interface element 40 and selecting element 42, may be embodied as software including instructions for carrying out the functions described herein. For example, the selection unit 24 may be embodied as a software package that may be added to the head unit 22 such that the corresponding instructions associated with the selection unit 24 may be executed by the processing element 26.

The GPS module 10, 12, 14 selected by the selection unit 24 may be designated as the lead module or, alternatively, the output of the selected GPS module may simply be allowed to pass to the head unit 22, while outputs from other GPS modules are terminated at the selection unit 24. In the context of the description provided below, the term lead module is a designation for indicating the selected GPS module actively providing position fix information for output at the head unit 22. The remaining GPS modules during any given period of time may be considered backup or spare modules. In this regard, the lead GPS module may be considered to operate in an active mode with respect to the head unit 22, while the spare GPS module may be considered to operate in an inactive mode with respect to the head unit 22.

It should be understood that the terms “lead” and “spare” are merely designations of GPS modules 10, 12, 14 that provide GPS positioning messages to the selection unit 24 at any particular time. Thus, these designations are descriptive of which GPS positioning message source provides GPS positioning messages that are used in generating location fix information (i.e., the lead module), and which GPS positioning message source(s) provide GPS positioning messages that are not used in generating fix information, at any particular time (i.e., the spare module(s)). As such, it should be understood that the terms lead and spare are merely descriptive of the function a particular GPS module at a particular time and in no way meant to be limiting in and of themselves.

In one exemplary embodiment, the selection unit 24 is configured to receive GPS positioning messages from each of the first, second and Nth GPS modules 10, 12 and 14, and configured to select one of the GPS modules as a lead module based on a comparison of the descriptive characteristic in the incoming GPS positioning messages to a descriptive characteristic of a more (e.g., most) recently received GPS positioning message from a currently selected lead module. In accordance with exemplary embodiments of the present invention, for example, selection of the lead module may be made automatically by the selection unit 24.

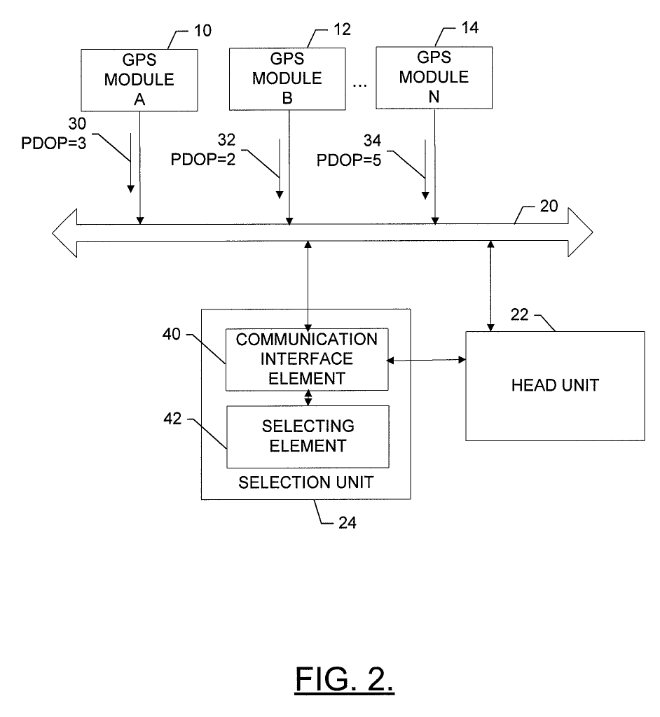

FIG. 2 is a basic block diagram illustrating operation of the system for automatically selecting a GPS module according to an exemplary embodiment of the present invention. Thus, in an exemplary embodiment, at the same or different times, during or after initial startup of the system, a first GPS positioning message 30 may be transmitted by the first GPS module 10, a second GPS positioning message 32 may be transmitted by the second GPS module 12, and an Nth GPS positioning message 34 may be transmitted by the Nth GPS module 14. For the purposes of example only, assume that the first GPS positioning message 30 has a PDOP value of three, the second GPS positioning message 32 has a PDOP value of two, and the Nth GPS positioning message 34 has a PDOP value of five.

Upon initial operation of the system, a lead module may be selected in any of a number of different manners. For example, a random one of the GPS modules 10, 12, 14 may be selected as the lead module, or a corresponding module last selected as the lead module may remain the lead module. As another alternative, for example, there may be no lead module selected until after a first comparison of the descriptive characteristic of GPS positioning messages received from the GPS modules, from which an initial lead module may be selected. In this regard, if no lead module is initially selected, upon receipt of the first, second and third GPS positioning messages 30, 32 and 34, the selection unit 24 may compare the PDOP values of each of the GPS positioning messages and select the GPS module associated with the GPS positioning message having the lowest PDOP (i.e., the second GPS module 12 in the example above) as the lead module. In other words, the selection unit 24 may select the GPS module associated with the highest quality measure as the lead module. The selection unit 24 may then either communicate to the head unit 22 only those GPS positioning messages received from the lead module, or otherwise indicate to the head unit 22 which of the GPS positioning messages are to be considered “active” based upon receiving the “active” messages from the lead module. Thus, only GPS positioning messages from the lead module will be output for location fixes at the head unit 22.

As indicated above, the GPS module 10, 12, 14 selected as the lead module may vary over time. The variance may be based on the corresponding descriptive characteristics of each incoming GPS positioning message. For example, the variance may be based on which GPS module has the lowest PDOP value at any given time. However, in order to avoid rapid switching of the lead module selection between multiple GPS modules that may otherwise occur if a simple comparison is made between descriptive characteristics of corresponding incoming GPS positioning messages, embodiments of the present invention may utilize a threshold that, if met, may result in switching the lead module selection. In other words, if the quality measure on a GPS positioning message from a spare module exceeds the quality measure of the last GPS positioning message received from the lead module by a threshold amount, then the spare module may be selected as the lead module and the former lead module may be designated as a spare module.

In an exemplary embodiment, once a lead module has been selected, location fixes output to the head unit 22 may be produced based only on GPS positioning messages received from the lead module. Accordingly, following the example above, since the second GPS module 12 provided the positioning message (i.e., second GPS positioning message 32), having the lowest PDOP value, the second GPS module 12 may be selected as the lead module and the head unit 22 will output location fixes responsive to only GPS positioning messages received from the second GPS module 12 for as long as the second GPS module 12 is selected as the lead module. As such, each incoming GPS positioning message received from the second GPS module 12 may be considered an “active” message for generating location fixes at the head unit 22. Meanwhile, each GPS positioning message received from the first GPS module 10 and the Nth GPS module 14 (i.e., the spare modules) may be considered an “inactive” message. The descriptive characteristic of each received inactive message may then be compared to the descriptive characteristic of a more current (e.g., last received) active message. If the descriptive characteristic of a particular received inactive message is different from (e.g., lower than in the case of PDOP values, higher than in the case of SNR, etc.) the descriptive characteristic of the most current active message by a threshold amount, the selection unit 24 may select the corresponding GPS module as the lead module, with the second GPS module 12 being designated as a spare module.

The threshold amount could be selected or otherwise set at any of a number of different times, and at any of a number of different values. For example, the threshold amount could be selected or otherwise set to a predetermined value set during manufacture of the selection unit 24. Additionally or alternatively, the threshold amount may be selected (or re-selected) by the user, such as directly by input to the selection unit 24, or indirectly by input to the head unit 22. For example, the threshold amount may be defined such that the inactive message having an associated PDOP value at least 0.5 lower than that of the active message may cause the selection unit 24 to switch the lead module selection. It should be noted again that PDOP is but one example of a descriptive characteristic and any other suitable descriptive characteristic could also be employed. Accordingly, with reference to PDOP, an inactive message may include a descriptive characteristic (i.e., PDOP) lower than that of the active message by a threshold amount in order to trigger a switch of the lead module selection. However, if SNR were utilized as the descriptive characteristic, the inactive message may instead include a descriptive characteristic (i.e., SNR) higher than that of the active message by the threshold amount in order to trigger the switch of the lead module selection.

Continuing with the example above describing an exemplary embodiment, assume that the second GPS module 12 is the lead module, and that the selection unit 24 receives a new GPS positioning message from the second GPS module 12 with a PDOP of 3.0. Further assume that the threshold amount is a PDOP value of 0.5. Thus, in response to receipt of a GPS positioning message from the first GPS module 10 having a PDOP of 2.8, the second GPS module 12 would remain the lead module and the most current GPS positioning message with the PDOP of 3.0 would be communicated to the head unit 22 for output as a location fix. Alternatively, in response to receipt of a GPS positioning message from the first GPS module 10 having a PDOP of 2.0, the first GPS module 12 would be selected as the lead module and the GPS positioning message received from the first GPS module 10 with the PDOP of 2.0 would be communicated to the head unit 22 for output as a location fix. Subsequently, for as long as the first GPS module 10 is designated as the lead module, incoming GPS positioning messages from the first GPS module 10 may continue to be communicated to the head unit 22 for output as corresponding location fixes.

As stated above, the descriptive characteristic upon which selection of the lead module is based may be any of numerous different characteristics. In an exemplary embodiment, the selection unit 24 may be capable of storing information related to past quality measures (e.g., PDOP values) of corresponding past GPS positioning messages. In other words, the selection unit 24 may store historical information (e.g., historical PDOP information) regarding descriptive characteristics for each corresponding GPS module. Accordingly, the selection unit 24 may be configured to utilize the stored historical information to calculate, for example, an average quality measure for each corresponding GPS module. Thus, the average quality measure for a particular GPS module may be the descriptive characteristic. The selection unit 24 may update the average quality measure for each GPS module in response to receipt of each corresponding GPS positioning message thereby enabling the selection unit 24 to compare an average quality measure of inactive GPS positioning messages received from a spare module to a corresponding average quality measure of active GPS positioning messages received from the lead module. In response to the average quality measure of the inactive GPS positioning messages from the respective spare module exceeding the average quality measure of the active GPS positioning messages received from the lead module, the selection unit may switch the selection of the respective spare and lead modules. It should be understood that if the quality measure is expressed in terms of error, as in the case of the PDOP, then a lower average PDOP for the spare module as compared to the lead module would be indicative of input GPS positioning messages from the spare module “exceeding” the average quality measure of the GPS positioning messages received from the lead module. In this regard, both a low error measure and a high accuracy measure may also be considered to be a high quality measure.

In an exemplary embodiment, the stored historical information could also include information related to a percentage of time, or total time during which a particular GPS module has exhibited a particular characteristic. For example, the stored historical information may include a percentage of time for which each corresponding GPS module has exhibited the lowest PDOP. In such instances, the stored historical information may be utilized by the selection unit 24 to calculate, for each of the GPS modules, a corresponding probability that a particular GPS module is likely to have, for example, the lowest PDOP. Thus, for example, the selection unit 24 may be capable of comparing a probability that inactive GPS positioning messages received from the spare module have a highest quality measure to a corresponding probability that active GPS positioning messages received from the lead module have the highest quality measure. The results of such a comparison may then be utilized in selecting one of the GPS modules as the lead module.

Alternatively, measures such as the average quality measure and the probability measure described above could be utilized in tie breaking in situations in which a plurality of spare modules both exceed the threshold by the same amount. In such a tie situation, rather than simply randomly selecting one of the respective spare modules as the new lead module, the average quality measure of the two spare modules and/or the probability that each of the spare modules has the highest or best (i.e., highest accuracy or lowest error) quality measure may be compared between the two spare modules in order to select which of the spare modules should be designated as the new lead module.

In one embodiment, the selection unit 24 may be activated or deactivated at the option of a user of the system. Thus, for example, a user interface provided at the head unit 22 may enable the functions associated with the selection unit 24, which have been described above, to be turned on and off. As such, when the selection unit 24 is turned off, automatic selection of a “best” GPS module (i.e., GPS module that is currently most accurate) may be disabled and a single module selected either randomly, or based on a user input, may remain the lead unit until another GPS module is manually selected (for example, via a user interface at the head unit 22) to be the lead module. However, in an exemplary embodiment of the present invention, even if the selection unit 24 is turned off, if the manually selected lead module fails to provide valid fix information, the selection unit 24 may provide for an automatic switch of the lead module designation to a random one of the spare modules or to a selected one of the spare modules based, for example, upon a selected descriptive characteristic. The selected descriptive characteristic may be defined, for example, based on a default setting that could be changed at the discretion of the user.

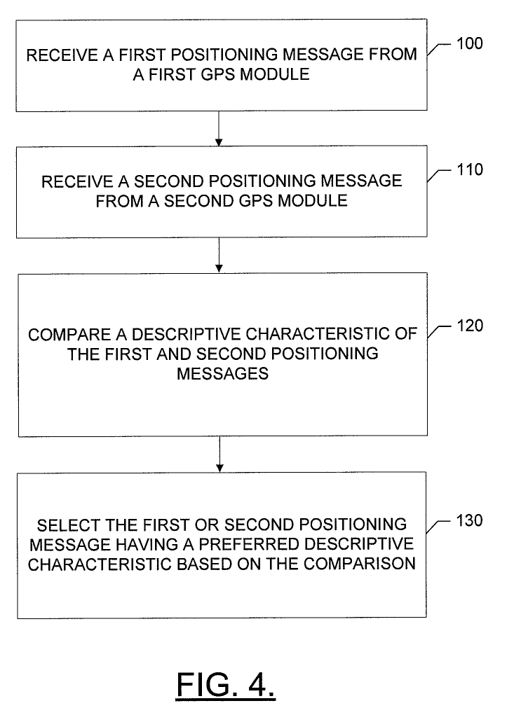

FIG. 4 is a flowchart of a system, method and program product according to an exemplary embodiment of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the head unit and executed by a built-in processor in the head unit. As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

One embodiment of a method of automatically selecting a GPS module, as shown in FIG. 4, includes receiving a GPS positioning message from a first GPS module at operation 100. At operation 110, a GPS positioning message may be received from a second GPS module. At operation 120, a descriptive characteristic of the GPS positioning messages received from the first and second GPS modules may be compared. At operation 130, the first or second GPS message having a preferred descriptive characteristic is selected. In an exemplary embodiment, the first GPS positioning message may be selected, the first GPS module being selected as a lead module and the second GPS module being designated as a spare module. After selecting the lead module, the first GPS positioning message and subsequent GPS positioning messages received from the lead module may be output as a position fix. During operation, and when the first GPS module is the lead module, a descriptive characteristic of subsequent second GPS positioning messages from the second GPS module may be compared to the corresponding descriptive characteristic of a first GPS positioning message more recently received from the lead module. If the descriptive characteristic of an subsequent second GPS positioning message is different from the corresponding descriptive characteristic of the more recently received first GPS positioning message from the lead module by at least a predetermined threshold amount, the subsequent second GPS positioning message may be selected. Thereafter, the second GPS module may be selected as the lead module, and the first GPS module may be designated as the spare module. In an exemplary embodiment, the user may select the descriptive characteristic from among a list of possible descriptive characteristics that the selection unit 24 is capable of detecting within a GPS positioning message. In another exemplary embodiment, the user may select a value of the predetermined threshold amount.

The above described functions may be carried out in many ways. For example, any suitable means for carrying out each of the functions described above may be employed to carry out embodiments of the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium. It should also be noted that although executable code portions described herein may be referred to as, for example, first, second or third executable portions for purposes of clarity, more than one of such executable portions may be performed by a particular thread or code segment.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for selecting a satellite navigation system module, the method comprising:
receiving a first positioning message from a first satellite navigation system module including a first receiver configured to receive satellite signals;
receiving a second positioning message from a second satellite navigation system module including a second receiver configured to receive satellite signals;
comparing a descriptive characteristic of the first and second positioning messages; and
selecting the first or second positioning message having a preferred descriptive characteristic based on the comparison.

2. The method of claim 1, wherein selecting the first or second positioning message comprises selecting the first positioning message, the first satellite navigation system module being selected as a lead module, and the second satellite navigation system module being designated as a spare module, wherein the method further comprises receiving a series of subsequent first and second positioning messages and outputting the subsequent first positioning messages received from the lead module as a position fix.

3. The method of claim 2, wherein comparing the descriptive characteristic comprises comparing a descriptive characteristic of the subsequent second positioning messages to a corresponding descriptive characteristic of a more recently received first positioning message from the lead module.

4. A method for selecting a satellite navigation system module, the method comprising:
receiving a first positioning message from a first satellite navigation system;
receiving a second positioning message from a second satellite navigation system module;
comparing a descriptive characteristic of the first and second positioning messages; and
selecting the first or second positioning message having a preferred descriptive characteristic based on the comparison,
wherein selecting the first or second positioning message comprises selecting the first positioning message, the first satellite navigation system module being selected as a lead module, and the second satellite navigation system module being designated as a spare module, wherein the method further comprises receiving a series of subsequent first and second positioning messages and outputting the subsequent first positioning messages received from the lead module as a position fix,
wherein comparing the descriptive characteristic comprises comparing a descriptive characteristic of the subsequent second positioning messages to a corresponding descriptive characteristic of a more recently received first positioning message from the lead module, and
wherein selecting the first or second positioning message further comprises selecting a subsequent second positioning message in response to the descriptive characteristic of the respective second positioning message being different from the corresponding descriptive characteristic of the more recently received first positioning message from the lead module by at least a predetermined threshold amount, the second satellite navigation system module thereafter being selected as the lead module, and the first satellite navigation system module thereafter being designated as the spare module.

5. The method of claim 2, further comprising receiving a user input to select the predetermined threshold amount.

6. The method of claim 1, wherein comparing the descriptive characteristic of first and second positioning messages comprises comparing a quality measure of the first positioning message to a corresponding quality measure of the second positioning message.

7. The method of claim 6, wherein comparing the quality measure of the first positioning message to the corresponding quality measure of the second positioning message comprises comparing a position dilution of precision (PDOP) measure of the first positioning message to a corresponding PDOP measure of the second positioning message.

8. The method of claim 1, wherein comparing the descriptive characteristic of the first and second positioning messages comprises comparing an average quality measure of a plurality of first positioning messages to a corresponding average quality measure of a plurality of second positioning messages.

9. The method of claim 1, wherein comparing the descriptive characteristic of the first and second positioning messages comprises comparing a probability that the first positioning message has a higher quality measure to a corresponding probability that the second positioning message has the higher quality measure.

10. The method of claim 1, further comprising receiving a user input to select the descriptive characteristic.

11. A computer program product for selecting a satellite navigation system module, the computer program product comprising at least one computer-readable storage medium having computer-readable program code portions stored therein, the computer-readable program code portions comprising:
a first executable portion for receiving a first positioning message from a first satellite navigation system module including a first receiver configured to receive satellite signals;
a second executable portion for receiving a second positioning message from a second satellite navigation system module including a second receiver configured to receive satellite signals;
a third executable portion for comparing a descriptive characteristic of the first and second positioning messages; and
a fourth executable portion for selecting the first or second positioning message having a preferred descriptive characteristic based on the comparison.

12. The computer program product of claim 11, wherein the fourth executable portion includes instructions for selecting the first positioning message, the first satellite navigation module being selected as a lead module, and the second satellite navigation system module being designated as a spare module, wherein the computer program product further comprises a fifth executable portion for receiving a series of subsequent first and second satellite navigation system messages and outputting the subsequent first positioning messages received from the lead module as a position fix.

13. The computer program product of claim 12, wherein the third executable portion includes instructions for comparing a descriptive characteristic of the subsequent second positioning messages to a corresponding descriptive characteristic of a more recently received first positioning message from the lead module.

14. A computer program product for selecting a satellite navigation system module, the computer program product comprising at least one computer-readable storage medium having computer-readable program code portions stored therein, the computer-readable program code portions comprising:
a first executable portion for receiving a first positioning message from a first satellite navigation system module;
a second executable portion for receiving a second positioning message from a second satellite navigation system module;
a third executable portion for comparing a descriptive characteristic of the first and second positioning messages; and
a fourth executable portion for selecting the first or second positioning message having a preferred descriptive characteristic based on the comparison,
wherein the fourth executable portion includes instructions for selecting the first positioning message, the first satellite navigation module being selected as a lead module, and the second satellite navigation system module being designated as a spare module, wherein the computer program product further comprises a fifth executable portion for receiving a series of subsequent first and second satellite navigation system messages and outputting the subsequent first positioning messages received from the lead module as a position fix,
wherein the third executable portion includes instructions for comparing a descriptive characteristic of the subsequent second positioning messages to a corresponding descriptive characteristic of a more recently received first positioning message from the lead module, and
wherein the fourth executable portion further includes instructions for selecting a subsequent second positioning message in response to the descriptive characteristic of the respective second positioning message being different from the corresponding characteristic of the more recently received first positioning message from the lead module by at least a predetermined threshold amount, the second satellite navigation system module thereafter being selected as the lead module, and the first satellite navigation system module thereafter being designated as the spare module.

15. The computer program product of claim 12, further comprising a sixth executable portion for receiving a user input to select the predetermined threshold amount.

16. The computer program product of claim 11, wherein the third executable portion includes instructions for comparing a quality measure of the first positioning message to a corresponding quality measure of the second positioning message.

17. The computer program product of claim 11, wherein the third executable portion includes instructions for comparing a position dilution of precision (PDOP) measure of the first positioning message to a corresponding PDOP measure of the second positioning message.

18. The computer program product of claim 11, wherein the third executable portion includes instructions for comparing an average quality measure of first positioning messages to a corresponding average quality measure of second positioning messages.

19. The computer program product of claim 11, wherein the third executable portion includes instructions for comparing a probability that the first positioning message has a higher quality measure to a corresponding probability that the second positioning message has the higher quality measure.

20. The computer program product of claim 11, further comprising a fifth executable portion for receiving a user input to select the descriptive characteristic.

21. An apparatus system for selecting a satellite navigation system module, the apparatus comprising:
a communication interface element configured to:
receive a first positioning message from a first satellite navigation system module including a first receiver configured to receive satellite signals; and
receive a second positioning message from a second satellite navigation system module including a second receiver configured to receive satellite signals; and
a selecting element configured to:
compare a descriptive characteristic of the first and second positioning messages; and
select the first or second positioning message having a preferred descriptive characteristic based on the comparison.

22. The apparatus of claim 21, wherein the selecting element is configured to select the first positioning message, the first satellite navigation module being selected as a lead module, and the second satellite navigation system module being designated as a spare module, wherein the communication interface element is further configured to:
receive a series of subsequent first and second positioning messages; and
output the subsequent first positioning messages received from the lead module as a position fix.

23. The apparatus of claim 22, wherein the selecting element is further configured to compare a descriptive characteristic of the subsequent second positioning messages to a corresponding descriptive characteristic of a more recently received first positioning message from the lead module.

24. An apparatus for selecting a satellite navigation system module, the apparatus comprising:
a communication interface element configured to:
receive a first positioning message from a first satellite navigation system module; and
receive a second positioning message from a second satellite navigation system module; and
a selecting element configured to:
compare a descriptive characteristic of the first and second positioning messages; and
select the first or second positioning message having a preferred descriptive characteristic based on the comparison,
wherein the selecting element is configured to select the first positioning message, the first satellite navigation module being selected as a lead module, and the second satellite navigation system module being designated as a spare module, wherein the communication interface element is further configured to:
receive a series of subsequent first and second positioning messages; and
output the subsequent first positioning messages received from the lead module as a position fix,
wherein the selecting element is further configured to compare a descriptive characteristic of the subsequent second positioning messages to a corresponding descriptive characteristic of a more recently received first positioning message from the lead module, and
wherein the selecting element is further configured to select a subsequent second positioning message in response to the descriptive characteristic of the respective second positioning message being different from the corresponding characteristic of the more recently received first positioning message from the lead module by at least a predetermined threshold amount, the second satellite navigation system module thereafter being selected as the lead module, and the first satellite navigation system module thereafter being designated as the spare module.

25. The apparatus of claim 22, wherein the selecting element is further configured to receive a user input to select the predetermined threshold amount.

26. The apparatus of claim 21, wherein the selecting element is further configured to compare a quality measure of the first positioning message to a corresponding quality measure of the second positioning message.

27. The apparatus of claim 21, wherein the selecting element is further configured to compare a position dilution of precision (PDOP) measure of the first positioning message to a corresponding PDOP measure of the second positioning message.

28. The apparatus of claim 21, wherein the selecting element is further configured to compare an average quality measure of first positioning messages to a corresponding average quality measure of second positioning messages.

29. The apparatus of claim 21, wherein the selecting element is further configured to compare a probability that the first positioning message has a higher quality measure to a corresponding probability that the second positioning message has the higher quality measure.

30. The apparatus of claim 21, the selecting element is further configured to receive a user input to select the descriptive characteristic.
